(19) United States
(12) Patent Application Publication
(10) Pub. No.: US 2014/0216749 A1
(43) Pub. Date: Aug. 7, 2014

(54) ELECTROCOAGULATION REDUCTION OF MAGNESIUM FROM SEAWATER FOR HIGH-pH or HIGH-TEMPERATURE TREATMENT

(71) Applicant: HALLIBURTON ENERGY SERVICES, INC., Houston, TX (US)

(72) Inventors: Paul D. Lord, Cypress, TX (US); Jim D. Weaver, Duncan, OK (US); Renee A. LeBas, Houston, TX (US)

(73) Assignee: HALLIBURTON ENERGY SERVICES, INC., Houston, TX (US)

(21) Appl. No.: 13/756,688

(22) Filed: Feb. 1, 2013

(51) Int. Cl. C09K 8/66; E21B 43/26; E21B 43/16

(52) U.S. Cl. CPC C09K 8/66; E21B 43/16; E21B 43/26
USPC 166/308.1; 507/270; 507/211; 507/214; 166/305.1

(57) ABSTRACT

A method of treating a well including the steps of: (A) treating a first aqueous fluid comprising seawater with electrocoagulation to obtain a second aqueous fluid, wherein the second aqueous fluid has a reduced concentration of magnesium ions relative to the original concentration of magnesium ions in the first aqueous fluid; (B) forming a treatment fluid comprising: (i) an aqueous phase, wherein the aqueous phase comprises the second aqueous fluid, and (ii) a viscosity-increasing agent in the aqueous phase; and (C) introducing the treatment fluid into a well. The aqueous phase can have a pH of at least about 9 or the treatment fluid can be introduced into a well at a design temperature of at least about 93° C. (200° F.).

### TECHNICAL FIELD

The inventions are in the field of producing crude oil or natural gas from subterranean formations. More specifically, the inventions generally relate to methods of using seawater in a treatment fluid having high pH or at high temperature while avoiding magnesium damage to a subterranean formation.

### BACKGROUND

Guar-based fracturing fluids typically require high pH in order to maintain sufficient rheological properties to transport proppant and to provide fluid leakoff control during high temperature hydraulic fracturing. Because of solubility issues, water that contains a high magnesium ion concentration tends to precipitate Mg(OH)₂ solids when the pH is elevated or at high temperature, which leads to a fluid that can cause severe permeability damage to a subterranean formation.

The conventional work around to this problem has been to use freshwater or desalinated water to manufacture high pH, guar-based fracturing fluids. Sometimes this requires very large volumes of freshwater to be transported long distances to a well site. In an alternative to transportation of freshwater, desalination is very expensive. In many well site locations, such as desert areas or offshore, freshwater is considered a precious commodity. However, there often is easy access to seawater.

### SUMMARY OF THE INVENTION

A method of treating a well is provided, the method comprising the steps of: (A) treating a first aqueous fluid comprising seawater with electrocoagulation to obtain a second aqueous fluid, wherein the second aqueous fluid has a reduced concentration of magnesium ions relative to the original concentration of magnesium ions in the first aqueous fluid; (B) forming a treatment fluid comprising: (i) an aqueous phase, wherein the aqueous phase comprises the second aqueous fluid, and (ii) a viscosity-increasing agent in the aqueous phase; and (C) introducing the treatment fluid into a well. In an embodiment, the aqueous phase has a pH at least about 9. In an embodiment, the treatment fluid is introduced into a well at a design temperature at least about 93° C. (200° F.). It should be understood that a method can have, for example, both a treatment fluid with an aqueous phase having a pH at least about 9 and wherein the treatment fluid is introduced into a well at a design temperature at least about 93° C. (200° F.).

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### BRIEF DESCRIPTION OF THE DRAWING

The accompanying drawing is incorporated into the specification to help illustrate examples according to the presently most-preferred embodiment of the invention.

FIG. 1 is an illustration of a treatment of seawater delivered to the well site before its initial use in a fracturing operation. The seawater can be delivered via a truck or pipeline or can be adjacent the well site, for example, if the well site is offshore.

FIG. 2 is a schematic that is to be taken with FIGS. 3 and 4 and shows a pre-treatment storage tank prior to EC treatment.

FIG. 3 is a schematic of a series of parallel EC treatment cells that receive fluid from the pre-treatment tank shown FIG. 2.

FIG. 4 is to be taken with FIGS. 2 and 3 and is a schematic showing a plurality of settling or “flocculation” tanks that receive fluid processed by the EC cells in FIG. 3, with the fluid being passed onto final stage processing through media filters.

FIG. 5 is a block schematic diagram showing the operational control of the EC system.

FIG. 6 is a block schematic diagram that illustrates electric current control for the EC system.

FIG. 7 is related to FIG. 6 and is a block diagram illustrating control of the tap settings in a transformer that makes up a portion of the EC system.

FIG. 8 is a graph demonstrating that the concentration of magnesium in seawater can be reduced by passing through an electrocoagulation unit (e.g., Halliburton's CLEANWAVE™ EC treatment). The columns represent the change in various cation ion concentrations from the initial concentrations after two passes through the EC unit.

FIG. 9 is a graph of the FANN™ Model 50 rheology results using a 4.2 kg/m³ (35 lb/Mgal) zirconium-based crosslink fluid at 163° C. (325° F.) with EC treated seawater that was passed through the system once, where the crosslink pH was 10.3.

### DETAILED DESCRIPTION OF PRESENTLY PREFERRED EMBODIMENTS AND BEST MODE

### Definitions and Usages

General Interpretation

The words or terms used herein have their plain, ordinary meaning in the field of this disclosure, except to the extent explicitly and clearly defined in this disclosure or unless the specific context otherwise requires a different meaning.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

It should be understood that algebraic variables and other scientific symbols used herein are selected arbitrarily or according to convention. Other algebraic variables can be used.

Terms such as “first,” “second,” “third,” etc. are assigned arbitrarily and are merely intended to differentiate between two or more components, parts, or steps that are otherwise similar or corresponding in nature, structure, function, or action. For example, the words “first” and “second” serve no other purpose and are not part of the name or description of the following name or descriptive terms. The mere use of the term “first” does not require that there be any “second” similar or corresponding component, part, or step. Similarly, the mere use of the word “second” does not require that there be any “first” or “third” similar or corresponding component, part, or step. Further, it is to be understood that the mere use of the term “first” does not require that the element or step be the very first in any sequence, but merely that it is at least one of the elements or steps. Similarly, the mere use of the terms “first” and “second” does not necessarily require any sequence. Accordingly, the mere use of such terms does not exclude intervening elements or steps between the “first” and “second” elements or steps, etc.

If there is any conflict in the usages of a word or term in this disclosure and one or more patent(s) or other documents that may be incorporated by reference, the definitions that are consistent with this specification should be adopted.

Oil and Gas Reservoirs

In the context of production from a well, “oil” and “gas” are understood to refer to crude oil and natural gas, respectively.

A “subterranean formation” is a body of rock that has sufficiently distinctive characteristics and is sufficiently continuous for geologists to describe, map, and name it. In the context of formation evaluation, a subterranean formation refers to the volume of rock seen by a measurement made through a wellbore, as in a log or a well test. These measurements indicate the physical properties of this volume of rock, such as the property of permeability.

A subterranean formation having a sufficient porosity and permeability to store and transmit fluids is sometimes referred to as a “reservoir.”

A subterranean formation containing oil or gas may be located under land or under the seabed offshore. Oil and gas reservoirs are typically located in the range of a few hundred feet (shallow reservoirs) to a few tens of thousands of feet (ultra-deep reservoirs) below the surface of the land or seabed.

Well Servicing and Fluids

To produce oil or gas from a reservoir, a wellbore is drilled into a subterranean formation, which may be the reservoir or adjacent to the reservoir. Typically, a wellbore of a well must be drilled hundreds or thousands of feet into the earth to reach a hydrocarbon-bearing formation.

Generally, well services include a wide variety of operations that may be performed in oil, gas, geothermal, or water wells, such as drilling, cementing, completion, and intervention. Well services are designed to facilitate or enhance the production of desirable fluids such as oil or gas from or through a subterranean formation. A well service usually involves introducing a fluid into a well.

Well Terms

A “well” includes a wellhead and at least one wellbore from the wellhead penetrating the earth. The “wellhead” is the surface termination of a wellbore, which surface may be on land or on a seabed.

A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well or any other tubulars in the well. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

As used herein, introducing “into a well” means introducing at least into and through the wellhead. According to various techniques known in the art, tubulars, equipment, tools, or fluids can be directed from the wellhead into any desired portion of the wellbore.

As used herein, the word “tubular” means any kind of structural body in the general form of a tube.

As used herein, the word “treatment” refers to any treatment for changing a condition of a portion of a wellbore, or a subterranean formation adjacent a wellbore; however, the word “treatment” does not necessarily imply any particular treatment purpose. A treatment usually involves introducing a fluid for the treatment, in which case it may be referred to as a treatment fluid, into a well. As used herein, a “treatment fluid” is a fluid used in a treatment. The word “treatment” in the term “treatment fluid” does not necessarily imply any particular treatment or action by the fluid.

A “zone” refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a fluid is directed to flow from the wellbore. As used herein, “into a treatment zone” means into and through the wellhead and, additionally, through the wellbore and into the treatment zone.

The term “design temperature” refers to an estimate or measurement of the actual temperature at the downhole environment during the time of a treatment. For example, the design temperature for a well treatment takes into account not only the bottom hole static temperature (“BHST”), but also the effect of the temperature of the fluid on the BHST during treatment. The design temperature for a fluid is sometimes referred to as the bottom hole circulation temperature (“BHCT”). Because fluids may be considerably cooler than BHST, the difference between the two temperatures can be quite large. Ultimately, if left undisturbed a subterranean formation will return to the BHST.

Substances, Chemicals, and Derivatives

A substance can be a pure chemical or a mixture of two or more different chemicals.

An ionic compound is made of distinguishable ions, including at least one cation (a positively charged ion) and at least one anion (a negatively charged ion), held together by electrostatic forces. An ion is an atom or molecule that has acquired a charge by either gaining or losing electrons. An ion can be a single atom or molecular. An ion can be separated from an ionic compound, for example, by dissolving the ions of the compound in a polar solvent.

As used herein, a “polymer” or “polymeric material” includes polymers, copolymers, terpolymers, etc. In addition, the term “copolymer” as used herein is not limited to the combination of polymers having two monomeric units, but includes any combination of monomeric units, e.g., terpolymers, tetrapolymers, etc.

As used herein, “modified” or “derivative” means a chemical compound formed by a chemical process from a parent compound, wherein the chemical backbone skeleton of the parent compound is retained in the derivative. The chemical process preferably includes at most a few chemical reaction steps, and more preferably only one or two chemical reaction steps. As used herein, a “chemical reaction step” is a chemical reaction between two chemical reactant species to produce at least one chemically different species from the reactants (regardless of the number of transient chemical species that may be formed during the reaction). An example of a chemical step is a substitution reaction. Substitution on the reactive sites of a polymeric material may be partial or complete.

As used herein, “guar-based” means guar or a derivative of guar.

Physical States and Phases

As used herein, “phase” is used to refer to a substance having a chemical composition and physical state that is distinguishable from an adjacent phase of a substance having a different chemical composition or a different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulates

As used herein, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers up to a large drop on the scale of a few millimeters.

As used herein, a particulate or particulate material refers to matter in the physical form of distinct particles in a solid or liquid state (which means such an association of a few atoms or molecules). As used herein, a particulate is a grouping of particles having similar chemical composition and particle size ranges anywhere in the range of about 0.5 micrometer (500 nm), e.g., microscopic clay particles, to about 3 millimeters, e.g., large grains of sand.

A particulate can be of solid or liquid particles. As used herein, however, unless the context otherwise requires, particulate refers to a solid particulate.

It should be understood that the terms “particle” and “particulate,” includes all known shapes of particles including substantially rounded, spherical, oblong, ellipsoid, rod-like, fiber, polyhedral (such as cubic materials), etc., and mixtures thereof. For example, the term “particulate” as used herein is intended to include solid particles having the physical shape of platelets, shavings, flakes, ribbons, rods, strips, spheroids, toroids, pellets, tablets or any other physical shape.

A particulate will have a particle size distribution (“PSD”). As used herein, “the size” of a particulate can be determined by methods known to persons skilled in the art.

One way to measure the approximate particle size distribution of a solid particulate is with graded screens. A solid particulate material will pass through some specific mesh (that is, have a maximum size; larger pieces will not fit through this mesh) but will be retained by some specific tighter mesh (that is, a minimum size; pieces smaller than this will pass through the mesh). This type of description establishes a range of particle sizes. A “+” before the mesh size indicates the particles are retained by the sieve, while a “−” before the mesh size indicates the particles pass through the sieve. For example, −70/+140 means that 90% or more of the particles will have mesh sizes between the two values.

Particulate materials are sometimes described by a single mesh size, for example, 100 U.S. Standard mesh. If not otherwise stated, a reference to a single particle size means about the mid-point of the industry-accepted mesh size range for the particulate.

The most commonly-used grade scale for classifying the diameters of sediments in geology is the Udden-Wentworth scale. According to this scale, a solid particulate having particles smaller than 2 mm in diameter is classified as sand, silt, or clay. Sand is a detrital grain between 2 mm (equivalent to 2,000 micrometers) and 0.0625 mm (equivalent to 62.5 micrometers) in diameter. (Sand is also a term sometimes used to refer to quartz grains or for sandstone.) Silt refers to particulate between 74 micrometers (equivalent to about −200 U.S. Standard mesh) and about 2 micrometers. Clay is a particulate smaller than 0.0039 mm (equivalent to 3.9 μm).

Dispersions

A dispersion is a system in which particles of a substance of one chemical composition and physical state are dispersed in another substance of a different chemical composition or physical state. In addition, phases can be nested. If a substance has more than one phase, the most external phase is referred to as the continuous phase of the substance as a whole, regardless of the number of different internal phases or nested phases.

A dispersion is considered to be heterogeneous if the dispersed particles are not dissolved and are greater than about 1 nanometer in size. (For reference, the diameter of a molecule of toluene is about 1 nm and a molecule of water is about 0.3 nm). Heterogeneous dispersions can have gas, liquid, or solid as an external phase. For example, in a case where the dispersed-phase particles are liquid in an external phase that is another liquid, this kind of heterogeneous dispersion is more particularly referred to as an emulsion. A solid dispersed phase in a continuous liquid phase is referred to as a sol, suspension, or slurry, partly depending on the size of the dispersed solid particulate.

A dispersion is considered to be homogeneous if the dispersed particles are dissolved in solution or the particles are less than about 1 nanometer in size. Even if not dissolved, a dispersion is considered to be homogeneous if the dispersed particles are less than about 1 nanometer in size.

Hydratability or Solubility

As referred to herein, “hydratable” means capable of being hydrated by contacting the hydratable agent with water. Regarding a hydratable agent that includes a polymer, this means, among other things, to associate sites on the polymer with water molecules and to unravel and extend the polymer chain in the water.

A substance is considered to be “soluble” in a liquid if at least 10 grams of the substance can be hydrated or dissolved in one liter of the liquid when tested at 25° C. (77° F.) and 1 atmosphere pressure for 2 hours, considered to be “insoluble” if less than 1 gram per liter, and considered to be “sparingly soluble” for intermediate solubility values.

As will be appreciated by a person of skill in the art, the hydratability, dispersibility, or solubility of a substance in water can be dependent on the salinity, pH, or other substances in the water. Accordingly, the salinity, pH, and additive selection of the water can be modified to facilitate the hydratability, dispersibility, or solubility of a substance in aqueous solution. To the extent not specified, the hydratability, dispersibility, or solubility of a substance in water is determined in deionized water, at neutral pH, and without any other additives.

Fluids

A fluid can be homogeneous or heterogeneous. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility.

Every fluid inherently has at least a continuous phase. A fluid can have more than one phase. The continuous phase of a treatment fluid is a liquid under Standard Laboratory Conditions. For example, a fluid can be in the form of a suspension (larger solid particles dispersed in a liquid phase), an emulsion (liquid particles dispersed in another liquid phase), or a foam (a gas phase dispersed in a liquid phase).

As used herein, a “water-based” fluid means that water or an aqueous solution is the dominant material of the continuous phase, that is, greater than 50% by weight, of the continuous phase of the fluid based on the combined weight of water and any other solvents in the phase (that is, excluding the weight of any dissolved solids).

In contrast, an “oil-based” fluid means that oil is the dominant material by weight of the continuous phase of the fluid. In this context, the oil of an oil-based fluid can be any oil.

Apparent Viscosity of a Fluid

Viscosity is a measure of the resistance of a fluid to flow. In everyday terms, viscosity is “thickness” or “internal friction.” Thus, pure water is “thin,” having a relatively low viscosity whereas honey is “thick,” having a relatively higher viscosity. Put simply, the less viscous the fluid is, the greater its ease of movement (fluidity). More precisely, viscosity is defined as the ratio of shear stress to shear rate.

A fluid moving along solid boundary will incur a shear stress on that boundary. The no-slip condition dictates that the speed of the fluid at the boundary (relative to the boundary) is zero, but at some distance from the boundary the flow speed must equal that of the fluid. The region between these two points is aptly named the boundary layer. For all Newtonian fluids in laminar flow, the shear stress is proportional to the strain rate in the fluid where the viscosity is the constant of proportionality However for non-Newtonian fluids, this is no longer the case as for these fluids the viscosity is not constant. The shear stress is imparted onto the boundary as a result of this loss of velocity.

Gels and Deformation

The physical state of a gel is formed by a network of interconnected molecules, such as a crosslinked polymer or a network of micelles. The network gives a gel phase its structure and an apparent yield point. At the molecular level, a gel is a dispersion in which both the network of molecules is continuous and the liquid is continuous. A gel is sometimes considered as a single phase.

Technically, a “gel” is a semi-solid, jelly-like physical state or phase that can have properties ranging from soft and weak to hard and tough. Shearing stresses below a certain finite value fail to produce permanent deformation. The minimum shear stress which will produce permanent deformation is referred to as the shear strength or gel strength of the gel.

In the oil and gas industry, however, the term “gel” may be used to refer to any fluid having a viscosity-increasing agent, regardless of whether it is a viscous fluid or meets the technical definition for the physical state of a gel. A “base gel” is a term used in the field for a fluid that includes a viscosity-increasing agent, such as guar, but that excludes crosslinking agents. Typically, a base gel is mixed with another fluid containing a crosslinker, wherein the mixture is adapted to form a crosslinked gel. Similarly, a “crosslinked gel” may refer to a substance having a viscosity-increasing agent that is crosslinked, regardless of whether it is a viscous fluid or meets the technical definition for the physical state of a gel.

As used herein, a substance referred to as a “gel” is subsumed by the concept of “fluid” if it is a pumpable fluid.

Viscosity and Gel Measurements

There are numerous ways of measuring and modeling viscous properties, and new developments continue to be made. The methods depend on the type of fluid for which viscosity is being measured. A typical method for quality assurance or quality control (QA/QC) purposes uses a couette device, such as a FANN™ Model 35 or 50 viscometer or a CHANDLER™ 5550 HPHT viscometer. Such a viscometer measures viscosity as a function of time, temperature, and shear rate. The viscosity-measuring instrument can be calibrated using standard viscosity silicone oils or other standard viscosity fluids.

Due to the geometry of most common viscosity-measuring devices, however, solid particulate, especially if larger than silt (larger than 74 micrometer), would interfere with the measurement on some types of measuring devices. Therefore, the viscosity of a fluid containing such solid particulate is usually inferred and estimated by measuring the viscosity of a test fluid that is similar to the fracturing fluid without any proppant or gravel that would otherwise be included. However, as suspended particles (which can be solid, gel, liquid, or gaseous bubbles) usually affect the viscosity of a fluid, the actual viscosity of a suspension is usually somewhat different from that of the continuous phase.

In general, a FANN™ Model 35 viscometer is used for viscosity measurements of less than about 30 mPa·s (cP). In addition, the Model 35 does not have temperature and pressure controls, so it is used for fluids at ambient conditions (that is, Standard Laboratory Conditions). Except to the extent otherwise specified, the apparent viscosity of a fluid having a viscosity of less than about 30 cP (excluding any suspended solid particulate larger than silt) is measured with a FANN™ Model 35 type viscometer with a bob and cup geometry using an R1 rotor, B1 bob, and F1 torsion spring at a shear rate of 511 sec⁻¹ (300 rpm) and at a temperature of 77° F. (25° C.) and a pressure of 1 atmosphere.

In general, a FANN™ Model 50 viscometer is used for viscosity measurements of greater than about 30 mPa·s (cP). The Model 50 has temperature and pressure controls. Except to the extent otherwise specified, the apparent viscosity of a fluid having a viscosity of greater than about 35 cP (excluding any suspended solid particulate larger than silt) is measured with a FANN™ Model 50 type viscometer with a bob and cup geometry using an R1 rotor, B5 bob, and 420 or 440 spring at a shear rate of 40 sec⁻¹ (47 rpm) and at a temperature of 25° C. (77° F.) and pressure about 500 psi.

As used herein, a substance is considered to be a pumpable fluid if it has an apparent viscosity less than 5,000 mPa·s (cP) (independent of any gel characteristic). For reference, the viscosity of pure water is about 1 mPa·s (cP).

As used herein, a fluid is considered to be “viscous” if it has an apparent viscosity of 10 mPa·s (cP) or higher. The viscosity of a viscous fluid is considered to break or be broken if the viscosity is greatly reduced. Preferably, although not necessarily for all applications depending on how high the initial viscosity of the fluid, the viscous fluid breaks to a viscosity of less than 50% of the viscosity or to less than 5 mPa·s (cP).

Formation Permeability & Damage

Permeability refers to how easily fluids can flow through a material. For example, if the permeability is high, then fluids will flow more easily and more quickly through the material. If the permeability is low, then fluids will flow less easily and more slowly through the material.

The term “damage” as used herein regarding a subterranean formation refers to undesirable deposits that may reduce its permeability. Examples of damaging deposits include precipitates, scale, skin, polymer residue, surfactant residue, and hydrates.

General Measurement Terms

Unless otherwise specified or unless the context otherwise clearly requires, any ratio or percentage means by weight.

Unless otherwise specified or unless the context otherwise clearly requires, the phrase “by weight of the water” means the weight of the water of an aqueous phase of the fluid without the weight of any viscosity-increasing agent, dissolved salt, suspended particulate, or other materials or additives that may be present in the water.

If there is any difference between U.S. or Imperial units, U.S. units are intended.

If all that is needed is to convert a volume in barrels to a volume in cubic meters without compensating for temperature variations, then 1 bbl equals 0.159 m³ or 42 U.S. gallons.

Unless otherwise specified, mesh sizes are in U.S. Standard Mesh.

### General Approach

A general purpose of the invention is to provide methods to produce high-pH treatment fluids for use in a well, wherein the treatment fluids are producing using seawater by the selective reduction of magnesium ions. Another general purpose of the invention is to provide methods to produce treatment fluids for use in a well at a high design temperature, wherein the treatment fluids are produced using seawater by the selective reduction of magnesium ions. The methods can produced treatment fluids having both a high pH and for us a well at a high design temperature.

Electocoagulation can be used to selectively reduce magnesium concentration in seawater, which allows the manufacture a non-damaging fluid (or at least the equivalent to one having an aqueous phase of 2% KCl). The amount of magnesium reduction will depend on many factors, such as the starting composition of the water, temperature, throughput rate, settling time, number of passes through the EC unit, and the composition, shape and size of the EC cells of the EC unit.

Applications for such high-pH treatment fluids include the use of viscosified treatment fluids for carrying a dispersed solid particulate, such as gravel for gravel packing or proppant for hydraulic fracturing or frac packing.

Most of the ions in seawater pose little problem in manufacturing stable treatment fluids having a high pH or for use at high temperature, with the notable exception of magnesium and, to a lesser extent, calcium.

By using electrocoagulation technology (such as Halliburton's CLEANWAVE™ Service), the concentration of magnesium ions in seawater can be selectively reduced to a level that permits formulation and use of high-pH or high-temperature treatment fluids with the EC treated seawater.

The magnesium ion concentration can be greatly reduced after passing through an EC unit. Except for sodium and potassium cations, some other cations are also affected, some by larger percentages, but since these other cations are present in the starting fluid at very low concentrations, the change has little effect on the total fluid composition. Magnesium, however, is present at a high concentration (greater than 1,000 mg/l) in seawater and a reduction in concentration provides a major improvement on a treatment fluid having a high pH or used at a high temperature, including on the resulting fluid turbidity.

The method avoids the requirement for freshwater to manufacture high-pH or high-temperature treatment fluids for use in various well treatments. The method permits the use of readily available seawater (even in the desert) to be used in place of freshwater for the manufacture of high-pH or high-temperature treatment fluids. The method also permits the use of EC offshore to minimize the transport of freshwater. It will provide better utilization of boat operations for offshore well sites.

The method will permit treatments with high-pH or high-temperature treatment fluids in offshore or desert regions at greatly reduced costs for water.

In general, a method of treating a well is provided, the method comprising the steps of: (A) treating a first aqueous fluid comprising seawater with electrocoagulation to obtain a second aqueous fluid, wherein the second aqueous fluid has a reduced concentration of magnesium ions relative to the original concentration of magnesium ions in the first aqueous fluid; (B) forming a treatment fluid comprising: (i) an aqueous phase, wherein the aqueous phase comprises the second aqueous fluid, and (ii) a viscosity-increasing agent in the aqueous phase; and (C) introducing the treatment fluid into a well. In an embodiment, the aqueous phase has a pH at least about 9. In an embodiment, the treatment fluid is introduced into a well at a design temperature at least about 93° C. (200° F.). It should be understood that a method can have, for example, both a treatment fluid with an aqueous phase having a pH at least about 9 and wherein the treatment fluid is introduced into a well at a design temperature at least about 93° C. (200° F.).

In one embodiment, the electrocoagulation treatment comprises the steps of: (A) adding caustic (e.g., sodium or potassium hydroxide) to the first aqueous fluid to increase the pH to at least about 9; (B) passing the first aqueous fluid through an electrocoagulation cell; (C) separating at least some of the magnesium from the first aqueous fluid to obtain the second aqueous fluid. More preferably, the caustic does not introduce calcium or magnesium ions into the first aqueous fluid.

Preferably, the original concentration of magnesium ions in the first aqueous fluid is greater than 1,000 mg/kg (ppm). Preferably, the reduced concentration of magnesium ions in the second aqueous fluid is less than 500 mg/kg (ppm).

Preferably, the reduced concentration of magnesium ions is less than 50% of the original concentration of magnesium ions in the first aqueous fluid. More preferably, the reduced concentration of magnesium ions is less than 40% of the original concentration of magnesium ions in the first aqueous fluid.

Preferably, the seawater is raw seawater. For example, the seawater is preferably not treated for desalination.

In one embodiment, the first aqueous fluid comprises at least 80% by weight seawater. More preferably, the first aqueous fluid comprises at least 90% by weight seawater. Most preferably, the first aqueous fluid consists essentially of seawater. In an embodiment, the first aqueous fluid comprises less than 20% flowback or produced water. For example, the first aqueous fluid may not include any flowback or produced water. In contrast to seawater, produced water usually does not have high concentration of magnesium concentration, but rather produced water usually has a high concentration of calcium.

In another embodiment, the first aqueous fluid comprises at least 5,000 mg/l of sodium ions, which need not be reduced for various treatment fluids having a high-pH. More preferably, the first aqueous fluid comprises at least 8,000 mg/l of sodium ions. Most preferably, the aqueous phase of the treatment fluid comprises at least 10,000 mg/l of sodium ions.

In another embodiment, the first aqueous fluid comprises greater than 50,000 mg/l of total dissolved solids. Seawater does not have such a high concentration of total dissolved solids.

Preferably, the aqueous phase of the treatment fluid comprises at least 80% by weight of the second aqueous fluid. More preferably, the aqueous phase of the treatment fluid comprises at least 90% by weight of the second aqueous fluid. Most preferably, the aqueous phase of the treatment fluid consists essentially of the second aqueous fluid.

Preferably, the aqueous phase of the treatment fluid comprises at least 5,000 mg/l of sodium ions. More preferably, the aqueous phase of the treatment fluid comprises at least 8,000 mg/l of sodium ions. Most preferably, the aqueous phase of the treatment fluid comprises at least 10,000 mg/l of sodium ions.

Preferably, the aqueous phase of the treatment fluid as a pH at least about 10. Most preferably, the aqueous phase of the treatment fluid has a pH in the range of about 10 to about 12.5. In general, the higher the design temperature, the higher the pH must be to maintain the desired fluid viscosity and stability.

Preferably, the step of introducing the treatment fluid is at a design temperature of at least about 107° C. (225° F.). More preferably, the design temperature is at least about 135° C. (275° F.). For example, the design temperature can be in the range of at least about 135° C. (275° F.) to about 204° C. (400° F.). Most preferably, the design temperature is in the range of about 135° C. (275° F.) to about 190° C. (375° F.).

Preferably, the viscosity increasing agent is selected from the group consisting of guar, guar derivatives, and cellulose derivatives, and any combination thereof. More preferably, the viscosity-increasing agent is selected from the group consisting of guar, guar derivatives, and any combination thereof.

Preferably, the treatment fluid further comprises a crosslinking agent for the viscosity-increasing agent. Preferably, the crosslinking agent comprises a borate or a multivalent transition metal.

In yet another embodiment, the treatment fluid additionally comprises a dispersed solid particulate. Preferably, the solid particulate is a proppant. Preferably, the solid particulate has a particulate size distribution in the range of 160 US mesh to 8 US mesh. Preferably, the proppant is selected from the group consisting of: silica sand, ground nut shells, ground fruit pits, sintered bauxite, glass, plastics, ceramic materials, processed wood, composite materials, resin coated particulates, and any combination of the foregoing.

Preferably, the step of introducing further comprises: directing the treatment fluid into a zone of a subterranean formation penetrated by a wellbore of the well. More preferably, the step of introducing further comprises: introducing the treatment fluid into the zone at a pressure above the fracture pressure for the zone.

Preferably, the method additionally comprises the steps of: (D) breaking the viscosity of the treatment fluid in the well; and (E) flowing back fluid from the well. Preferably, the step of breaking comprises: lowering the pH of the treatment fluid to less than about 8.

In another embodiment, a method of fracturing a zone of a subterranean formation penetrated by a wellbore of a well is provided, the method comprising the steps of: (A) treating a first aqueous fluid comprising seawater with electrocoagulation to obtain a second aqueous fluid, wherein the second aqueous fluid has a reduced concentration of magnesium ions relative to the original concentration of magnesium ions in the first aqueous fluid; (B) forming a treatment fluid comprising: (i) an aqueous phase, wherein the aqueous phase comprises the second aqueous fluid and wherein the aqueous phase has a pH at least about 9, (ii) a viscosity-increasing agent in the aqueous phase, wherein the viscosity-increasing agent is guar-based; and (iv) a crosslinker; (C) introducing the treatment fluid into the zone at a rate and pressure sufficient to create or enhance a fracture in the subterranean formation; (D) breaking the viscosity of the treatment fluid in the zone by reducing the pH of the fluid to less than about 8; and (E) flowing back fluid from the zone.

Additional details regarding applications of the methods to hydraulic fracturing treatments, water considerations, and electrocoagulation techniques, other additives, and optional or preferred method steps are included below.

As will be appreciated, the various elements or steps according to the disclosed elements or steps can be combined advantageously or practiced together in various combinations or sub-combinations of elements or sequences of steps to increase the efficiency and benefits that can be obtained from the invention.

### Hydraulic Fracturing

Hydraulic fracturing is a stimulation treatment. The purpose of a hydraulic fracturing treatment is to provide an improved flow path for oil or gas to flow from the hydrocarbon-bearing formation to the wellbore. In addition, a fracturing treatment can facilitate the flow of injected treatment fluids from the well into the formation. A treatment fluid adapted for this purpose is sometimes referred to as a fracturing fluid. The fracturing fluid is pumped at a sufficiently high flow rate and pressure into the wellbore and into the subterranean formation to create or enhance one or more fractures in the subterranean formation. Creating a fracture means making a new fracture in the formation Enhancing a fracture means enlarging a pre-existing fracture in the formation.

A frac pump is used for hydraulic fracturing. A frac pump is a high-pressure, high-volume pump. Typically, a frac pump is a positive-displacement reciprocating pump. The structure of such a pump is resistant to the effects of pumping abrasive fluids, and the pump is constructed of materials that are resistant to the effects of pumping corrosive fluids. The fracturing fluid may be pumped down into the wellbore at high rates and pressures, for example, at a flow rate in excess of 50 barrels per minute (2,100 U.S. gallons per minute) at a pressure in excess of 5,000 pounds per square inch (“psi”). The pump rate and pressure of the fracturing fluid may be even higher, for example, flow rates in excess of 100 barrels per minute and pressures in excess of 10,000 psi are often encountered.

Fracturing a subterranean formation often uses hundreds of thousands of gallons of fracturing fluid or more. Further, it is often desirable to fracture more than one treatment zone of a well. Thus, a high volume of fracturing fluids is often used in fracturing of a well, which means that a low-cost fracturing fluid is desirable. Because of the ready availability and relative low cost of water compared to other liquids, among other considerations, a fracturing fluid is usually water-based.

The formation or extension of a fracture in hydraulic fracturing may initially occur suddenly. When this happens, the fracturing fluid suddenly has a fluid flow path through the fracture to flow more rapidly away from the wellbore. As soon as the fracture is created or enhanced, the sudden increase in the flow of fluid away from the well reduces the pressure in the well. Thus, the creation or enhancement of a fracture in the formation may be indicated by a sudden drop in fluid pressure, which can be observed at the wellhead. After initially breaking down the formation, the fracture may then propagate more slowly, at the same pressure or with little pressure increase. It can also be detected with seismic techniques.

A newly-created or newly-extended fracture will tend to close together after the pumping of the fracturing fluid is stopped. To prevent the fracture from closing, a material is usually placed in the fracture to keep the fracture propped open and to provide higher fluid conductivity than the matrix of the formation. A material used for this purpose is referred to as a proppant.

A proppant is in the form of a solid particulate, which can be suspended in the fracturing fluid, carried downhole, and deposited in the fracture to form a proppant pack. The proppant pack props the fracture in an open condition while allowing fluid flow through the permeability of the pack. The proppant pack in the fracture provides a higher-permeability flow path for the oil or gas to reach the wellbore compared to the permeability of the matrix of the surrounding subterranean formation. This higher-permeability flow path increases oil and gas production from the subterranean formation.

A particulate for use as a proppant is usually selected based on the characteristics of size range, crush strength, and solid stability in the types of fluids that are encountered or used in wells. Preferably, a proppant should not melt, dissolve, or otherwise degrade from the solid state under the downhole conditions.

The proppant is selected to be an appropriate size to prop open the fracture and bridge the fracture width expected to be created by the fracturing conditions and the fracturing fluid. If the proppant is too large, it will not easily pass into a fracture and will screenout too early. If the proppant is too small, it will not provide the fluid conductivity to enhance production. See, for example, W. J. McGuire and V. J. Sikora, “The Effect of Vertical Fractures on Well Productivity,” Trans., AIME (1960) 219, 401-403. In the case of fracturing relatively permeable or even tight-gas reservoirs, a proppant pack should provide higher permeability than the matrix of the formation. In the case of fracturing ultra-low permeable formations, such as shale formations, a proppant pack should provide for higher permeability than the naturally occurring fractures or other micro-fractures of the fracture complexity.

Appropriate sizes of particulate for use as a proppant are typically in the range from about 8 to about 100 U.S. Standard Mesh. A typical proppant is sand-sized, which geologically is defined as having a largest dimension ranging from about 0.06 millimeters up to about 2 millimeters (mm) (The next smaller particle size class below sand size is silt, which is defined as having a largest dimension ranging from less than about 0.06 mm down to about 0.004 mm.) As used herein, proppant does not mean or refer to suspended solids, silt, fines, or other types of insoluble solid particulate smaller than about 0.06 mm (about 230 U.S. Standard Mesh). Further, it does not mean or refer to particulates larger than about 3 mm (about 7 U.S. Standard Mesh).

The proppant is sufficiently strong, that is, has a sufficient compressive or crush resistance, to prop the fracture open without being deformed or crushed by the closure stress of the fracture in the subterranean formation. For example, for a proppant material that crushes under closure stress, a 20/40 mesh proppant preferably has an API crush strength of at least 4,000 psi closure stress based on 10% crush fines according to procedure API RP-56. A 12/20 mesh proppant material preferably has an API crush strength of at least 4,000 psi closure stress based on 16% crush fines according to procedure API RP-56. This performance is that of a medium crush-strength proppant, whereas a very high crush-strength proppant would have a crush-strength of about 10,000 psi. In comparison, for example, a 100-mesh proppant material for use in an ultra-low permeable formation such as shale preferably has an API crush strength of at least 5,000 psi closure stress based on 6% crush fines. The higher the closing pressure of the formation of the fracturing application, the higher the strength of proppant is needed. The closure stress depends on a number of factors known in the art, including the depth of the formation.

Further, a suitable proppant should be stable over time and not dissolve in fluids commonly encountered in a well environment. Preferably, a proppant material is selected that will not dissolve in water or crude oil.

Suitable proppant materials include, but are not limited to, silica sand, ground nut shells, ground fruit pits, sintered bauxite, glass, plastics, ceramic materials, processed wood, composite materials, resin coated particulates, and any combination of the foregoing. Mixtures of different kinds or sizes of proppant can be used as well.

In conventional reservoirs, a proppant commonly has a median size anywhere within the range of about 20 to about 100 U.S. Standard Mesh. For a synthetic proppant, it commonly has a median size anywhere within the range of about 8 to about 100 U.S. Standard Mesh.

The concentration of proppant in the treatment fluid depends on the nature of the subterranean formation. As the nature of subterranean formations differs widely, the concentration of proppant in the treatment fluid may be in the range of from about 0.03 kilograms to about 12 kilograms of proppant per liter of liquid phase (from about 0.1 lb/gal to about 25 lb/gal).

In some embodiments, a resinous material can be coated on the proppant. The term “coated” does not imply any particular degree of coverage on the proppant particulates, which coverage can be partial or complete. As used herein, the term “resinous material” means a material that is a viscous liquid and has a sticky or tacky characteristic when tested under Standard Laboratory Conditions. A resinous material can include a resin, a tackifying agent, and any combination thereof in any proportion. The resin can be or include a curable resin.

### Carrier Fluid for Particulate

A fluid can be adapted to be a carrier fluid for particulates. For example, a proppant used in fracturing or a gravel used in gravel packing may have a much different density than the carrier fluid. For example, silica sand has a specific gravity of about 2.7, whereas water has a specific gravity of 1.0 at Standard Laboratory Conditions of temperature and pressure. A proppant or gravel having a different density than water will tend to separate from water very rapidly.

Increasing the viscosity of a fluid can help prevent a particulate having a different specific gravity than a surrounding phase of the fluid from quickly separating out of the fluid.

A viscosity-increasing agent can be used to increase the ability of a fluid to suspend and carry a particulate material in a fluid. A viscosity-increasing agent can be used for other purposes, such as matrix diversion, conformance control, or friction reduction.

A viscosity-increasing agent is sometimes referred to in the art as a viscosifying agent, viscosifier, thickener, gelling agent, or suspending agent. In general, any of these refers to an agent that includes at least the characteristic of increasing the viscosity of a fluid in which it is dispersed or dissolved. There are several kinds of viscosity-increasing agents or techniques for increasing the viscosity of a fluid.

Polymers for Increasing Viscosity

Certain kinds of polymers can be used to increase the viscosity of a fluid. In general, the purpose of using a polymer is to increase the ability of the fluid to suspend and carry a particulate material. Polymers for increasing the viscosity of a fluid are preferably soluble in the external phase of a fluid. Polymers for increasing the viscosity of a fluid can be naturally occurring polymers such as polysaccharides, derivatives of naturally occurring polymers, or synthetic polymers.

Treatment fluids used in high volumes, such as fracturing fluids, are usually water-based. Efficient and inexpensive viscosity-increasing agents for water include certain classes of water-soluble polymers.

As will be appreciated by a person of skill in the art, the dispersibility or solubility in water of a certain kind of polymeric material may be dependent on the salinity or pH of the water. Accordingly, the salinity or pH of the water can be modified to facilitate the dispersibility or solubility of the water-soluble polymer. In some cases, the water-soluble polymer can be mixed with a surfactant to facilitate its dispersibility or solubility in the water or salt solution utilized.

The water-soluble polymer can have an average molecular weight in the range of from about 50,000 to 20,000,000, most preferably from about 100,000 to about 4,000,000. For example, guar polymer is believed to have a molecular weight in the range of about 2 million to about 4 million.

Typical water-soluble polymers used in well treatments include water-soluble polysaccharides and water-soluble synthetic polymers (e.g., polyacrylamide). The most common water-soluble polysaccharides employed in well treatments are guar and its derivatives.

A polymer can be classified as being single chain or multi chain, based on its solution structure in aqueous liquid media. Examples of single-chain polysaccharides that are commonly used in the oilfield industry include guar, guar derivatives, and cellulose derivatives. Guar polymer, which is derived from the beans of a guar plant, is referred to chemically as a galactomannan gum. Examples of multi-chain polysaccharides include xanthan, diutan, and scleroglucan, and derivatives of any of these.

A guar derivative can be selected from the group consisting of, for example, a carboxyalkyl derivative of guar, a hydroxyalkyl derivative of guar, and any combination thereof. Preferably, the guar derivative is selected from the group consisting of carboxymethylguar, carboxymethylhydroxyethylguar, carboxymethylhydroxypropylguar (“CMHPG”), ethylcarboxymethylguar, hydroxyethylguar, hydroxypropylmethylguar, and hydroxylpropylguar (“HPG”).

A cellulose derivative can be selected from the group consisting of, for example, a carboxyalkyl derivative of cellulose, a hydroxyalkyl derivative of cellulose, and any combination thereof. Preferably, the cellulose derivative is selected from the group consisting of carboxymethylcellulose, carboxymethylhydroxyethylcellulose, hydroxyethylcellulose, methylcellulose, ethylcellulose, ethylcarboxymethylcellulose, and hydroxypropylmethylcellulose.

The viscosity-increasing agent can be provided in any form that is suitable for the particular treatment fluid or application. For example, the viscosity-increasing agent can be provided as a liquid, gel, suspension, or solid additive that is incorporated into a treatment fluid.

If used, a viscosity-increasing agent may be present in the fluids in a concentration in the range of from about 0.01% to about 5% by weight of the water of the continuous phase.

Crosslinking of Polymer to Increase Viscosity of a Fluid or Form a Gel

The viscosity of a fluid at a given concentration of viscosity-increasing agent can be greatly increased by crosslinking the viscosity-increasing agent. A crosslinking agent, sometimes referred to as a crosslinker, can be used for this purpose. A crosslinker interacts with at least two polymer molecules to form a “crosslink” between them.

If crosslinked to a sufficient extent, the polysaccharide may form a gel with water. Gel formation is based on a number of factors including the particular polymer and concentration thereof, the particular crosslinker and concentration thereof, the degree of crosslinking, temperature, and a variety of other factors known to those of ordinary skill in the art.

For example, one of the most common viscosity-increasing agents used in the oil and gas industry is guar. A mixture of guar dissolved in water forms a base gel, and a suitable crosslinking agent can be added to form a much more viscous fluid, which is then called a crosslinked fluid. The viscosity of base gels of guar is typically about 20 to about 50 mPa·s (cP). When a base gel is crosslinked, the viscosity is increased by 2 to 100 times depending on the temperature, the type of viscosity testing equipment and method, and the type of crosslinker used.

The degree of crosslinking depends on the type of viscosity-increasing polymer used, the type of crosslinker, concentrations, temperature of the fluid, etc. Shear is usually required to mix the base gel and the crosslinking agent. Thus, the actual number of crosslinks that are possible and that actually form also depends on the shear level of the system. The exact number of crosslink sites is not well known, but it could be as few as one to about ten per polymer molecule. The number of crosslinks is believed to significantly alter fluid viscosity.

For a polymeric viscosity-increasing agent, any crosslinking agent that is suitable for crosslinking the chosen monomers or polymers may be used.

Cross-linking agents typically comprise at least one metal ion that is capable of cross-linking the viscosity-increasing agent molecules.

Some crosslinking agents form substantially permanent crosslinks with viscosity-increasing polymer molecules. Such crosslinking agents include, for example, crosslinking agents of at least one metal ion that is capable of crosslinking gelling agent polymer molecules. Examples of such crosslinking agents include, but are not limited to, zirconium compounds (such as, for example, zirconium lactate, zirconium lactate triethanolamine, zirconium carbonate, zirconium acetylacetonate, zirconium maleate, zirconium citrate, zirconium oxychloride, and zirconium diisopropylamine lactate); titanium compounds (such as, for example, titanium lactate, titanium maleate, titanium citrate, titanium ammonium lactate, titanium triethanolamine, and titanium acetylacetonate); aluminum compounds (such as, for example, aluminum acetate, aluminum lactate, or aluminum citrate); antimony compounds; chromium compounds; iron compounds (such as, for example, iron chloride); copper compounds; zinc compounds; sodium aluminate; or a combination thereof.

Crosslinking agents can include a crosslinking agent composition that may produce delayed crosslinking of an aqueous solution of a crosslinkable organic polymer, as described in U.S. Pat. No. 4,797,216, the entire disclosure of which is incorporated herein by reference. Crosslinking agents can include a crosslinking agent composition that may include a zirconium compound having a valence of +4, an alpha-hydroxy acid, and an amine compound as described in U.S. Pat. No. 4,460,751, the entire disclosure of which is incorporated herein by reference.

Some crosslinking agents do not form substantially permanent crosslinks, but rather chemically labile crosslinks with viscosity-increasing polymer molecules. For example, a guar-based gelling agent that has been crosslinked with a borate-based crosslinking agent does not form permanent cross-links

Borates have the chemical formula B(OR)₃, where B=boron, O=oxygen, and R=hydrogen or any organic group. At higher pH ranges, e.g., 8 or above, a borate is capable of increasing the viscosity of an aqueous solution of a water-soluble polymeric material such as a galactomannan or a polyvinyl alcohol. Afterwards, if the pH is lowered, e.g., below 8, the observed effect on increasing the viscosity of the solution can be reversed to reduce or “break” the viscosity back toward its original lower viscosity. It is also well known that, at lower pH ranges, e.g., below about 8, borate does not increase the viscosity of such a water-soluble polymeric material. This effect of borate and response to pH provides a commonly used technique for controlling the cross-linking of certain polymeric viscosity-increasing agents. The control of increasing the viscosity of such fluids and the subsequent “breaking” of the viscosity tends to be sensitive to several factors, including the particular borate concentration in the solution.

For example, by increasing the pH of a fluid to 8 or above, although usually in the range of about 8.5 to about 12, a borate-releasing compound such as boric acid releases borate ions, which become available for cross-linking a water-soluble polymer having alcohol sites. By subsequently lowering the pH of the fluid to a pH of below about 8, for example, by adding or releasing an acid into the fluid, the equilibrium shifts such that less of the borate anion species is in solution, and the cross-linking can be broken, thereby returning such a crosslinked fluid to a much lower viscosity.

In general, the higher the design temperature, the higher the pH must be to maintain the desired fluid viscosity and stability. Tables 1, 2, and 3 illustrate the need for higher pH with increasing temperature for several different guar-based fracturing fluids.

TABLE 1

| Polymer | Crosslinker | Temperature ° F. | pH |
|---|---|---|---|
| Guar | Borate | 75 | 9.5 |
| Guar | Borate | 100 | 9.5 |
| Guar | Borate | 125 | 10 |
| Guar | Borate | 150 | 10 |
| Guar | Borate | 175 | 10.5 |
| Guar | Borate | 200 | 10.5 |
| Guar | Borate | 225 | 11 |
| Guar | Borate | 250 | 11.5 |
| Guar | Borate | 275 | 12 |
| Guar | Borate | 300 | 12.5 |

TABLE 2

| Polymer | Crosslinker | Temperature, ° F. | pH |
|---|---|---|---|
| HPG | Borate | 75 | 9.5 |
| HPG | Borate | 100 | 9.5 |
| HPG | Borate | 125 | 10 |
| HPG | Borate | 150 | 10 |
| HPG | Borate | 175 | 10.5 |
| HPG | Borate | 200 | 10.5 |
| HPG | Borate | 225 | 11 |
| HPG | Borate | 250 | 11.5 |
| HPG | Borate | 275 | 12 |
| HPG | Borate | 300 | 12.5 |

TABLE 3

| Polymer | Crosslinker | Temperature, ° F. | pH |
|---|---|---|---|
| CMHPG | Zirconium Based | 175-375 | 9.7-10.7 |

Where present, the cross-linking agent generally should be included in the fluids in an amount sufficient, among other things, to provide the desired degree of cross linking In some embodiments, the cross-linking agent may be present in the treatment fluids in an amount in the range of from about 0.01% to about 5% by weight of the water in the treatment fluid.

Buffering compounds may be used if desired, e.g., to delay or control the cross linking reaction. These may include glycolic acid, carbonates, bicarbonates, acetates, phosphates, and any other suitable buffering agent.

Sometimes, however, crosslinking is undesirable, as it may cause the polymeric material to be more difficult to break and it may leave an undesirable residue in the formation.

Breaker for Viscosity of Fluid or Filtercake

After a treatment fluid is placed where desired in the well and for the desired time, the fluid usually must be removed from the wellbore or the formation. For example, in the case of hydraulic fracturing, the fluid should be removed leaving the proppant in the fracture and without damaging the conductivity of the proppant bed. To accomplish this removal, the viscosity of the treatment fluid must be reduced to a very low viscosity, preferably near the viscosity of water, for optimal removal from the propped fracture. Similarly, when a viscosified fluid is used for gravel packing, the viscosified fluid must be removed from the gravel pack.

Reducing the viscosity of a viscosified treatment fluid is referred to as “breaking” the fluid. Chemicals used to reduce the viscosity of treatment fluids are called breakers. Other types of viscosified fluids also need to be broken for removal from the wellbore or subterranean formation.

No particular mechanism is necessarily implied by the term. For example, a breaker can reduce the molecular weight of a water-soluble polymer by cutting the long polymer chain. As the length of the polymer chain is cut, the viscosity of the fluid is reduced. This process can occur independently of any crosslinking bonds existing between polymer chains.

In the case of a crosslinked viscosity-increasing agent, for example, one way to diminish the viscosity is by breaking the crosslinks For example, the borate crosslinks in a borate-crosslinked polymer can be broken by lowering the pH of the fluid. At a pH above 8, the borate ion exists and is available to crosslink and cause an increase in viscosity or gelling. At a lower pH, the borate ion reacts with a proton and is not available for crosslinking, thus, an increase in viscosity due to borate crosslinking is reversible. In contrast, crosslinks formed by zirconium, titanium, antimony, and aluminum compounds, however, are considered non-reversible and are broken by other methods than controlling pH.

Thus, removal of the treatment fluid is facilitated by using one or more breakers to reduce fluid viscosity.

A breaker should be selected based on its performance in the temperature, pH, time, and desired viscosity profile for each specific treatment.

In fracturing, for example, the ideal viscosity versus time profile would be if a fluid maintained 100% viscosity until the fracture closed on proppant and then immediately broke to a thin fluid. Some breaking inherently occurs during the 0.5 to 4 hours required to pump most fracturing treatments. One guideline for selecting an acceptable breaker design is that at least 50% of the fluid viscosity should be maintained at the end of the pumping time. This guideline may be adjusted according to job time, desired fracture length, and required fluid viscosity at reservoir temperature. A typical gravel pack break criteria is a minimum 4-hour break time.

Chemical breakers used to reduce viscosity of a fluid viscosified with a viscosity-increasing agent or to help remove a filtercake formed with such a viscosity-increasing agent are generally grouped into three classes: oxidizers, enzymes, and acids.

A breaker may be included in a treatment fluid in a form and concentration at selected to achieve the desired viscosity reduction at a desired time.

The breaker may be formulated to provide a delayed break, if desired. For example, a suitable breaker may be encapsulated if desired. Suitable encapsulation methods are known to those skilled in the art. One suitable encapsulation method involves coating the selected breaker in a porous material that allows for release of the breaker at a controlled rate. Another suitable encapsulation method that may be used involves coating the chosen breakers with a material that will degrade when downhole so as to release the breaker when desired. Resins that may be suitable include, but are not limited to, polymeric materials that will degrade when downhole.

A treatment fluid can optionally include an activator or a retarder to, among other things, optimize the break rate provided by a breaker. Examples of such activators include, but are not limited to, acid generating materials, chelated iron, copper, cobalt, and reducing sugars. Examples of retarders include sodium thiosulfate, methanol, and diethylenetriamine.

Delayed breakers, activators, and retarders can be used to help control the breaking of a fluid, but these may add additional complexity and cost to the design of a treatment fluid.

### Water Quality and Sources

There are various methods of describing water quality, for example, total dissolved solids, ion types in water, or ionic strength.

Solids are found in water in two basic forms, suspended and dissolved. Suspended solids include silt, stirred-up bottom sediment, decaying plant matter, or sewage-treatment effluent. Suspended solids will not pass through a filter, whereas dissolved solids will.

Total dissolved solids (“TDS”) refers to the sum of all minerals, metals, cations, and anions dissolved in water. As most of the dissolved solids are typically salts, the amount of salt in water is often described by the concentration of total dissolved solids in the water.

Dissolved solids in typical freshwater samples include soluble salts that yield ions such as sodium (Na⁺), calcium (Ca²⁺), magnesium (Mg²⁺), bicarbonate (HCO₃⁻), sulfate (SO₄²⁻), or chloride (Cl⁻). Water that contains significant amounts of dissolved salts is sometimes broadly called saline water or brine, and is expressed as the amount (by weight) of TDS in water in mg/l. On average, seawater in the world's oceans has a salinity of about 3.5%, or 35 parts per thousand. More than 70 elements are dissolved in seawater, but only six elements make up greater than 99% by weight.

Total dissolved solids can be determined by evaporating a pre-filtered sample to dryness, and then finding the mass of the dry residue per liter of sample. A second method uses a Vernier Conductivity Probe to determine the ability of the dissolved salts in an unfiltered sample to conduct an electrical current. The conductivity is then converted to TDS. Either of these methods yields a TDS value, typically reported in units of mg/L (or ppm).

Although the specific ranges of TDS for various types of water are not universally agreed upon, as used herein, the terms for classifying water based on concentration of TDS will generally be understood as defined in Table 4.

TABLE 4
A Classification of Water Based on TDS

| | TDS Concentration Ranges | | Density @ 20° C. | |
|---|---|---|---|---|
| Water | Ppm | lb/gal (U.S.) | g/ml | lb/gal (U.S.) |
| Potable | <250 | <0.0021 | | |
| Freshwater | <1,000 | <0.0083 | <0.998 | <8.33 |
| Brackish | 1,000-15,000 | 0.0083-0.0417 | | |
| Saline | 15,000-30,000 | 0.0417-0.1251 | | |
| Seawater | 30,000-40,000 | 0.1251-0.3338 | 1.020-1.029 | 8.51-8.59 |
| Brine | >40,000 | >0.3338 | | |

The average composition of seawater, as reported by Karl K. Turekian, Oceans, 1968, Prentice-Hall, is shown in Table 5.

TABLE 5
Typical Composition of Seawater

| | Concentration |
|---|---|
| Dissolved Ion | mg/kg (ppm) |
| Chloride (Cl⁻) | 19,345 |
| Sodium (Na⁺) | 10,752 |
| Sulfate (SO₄²⁻) | 2701 |
| Magnesium (Mg²⁺) | 1295 |
| Calcium (Ca²⁺) | 416 |
| Potassium (K⁺) | 390 |
| Bicarbonate (HCO₃²⁻) | 145 |
| Bromide (Br⁻) | 66 |
| Borate (BO₃²⁻) | 27 |
| Strontium (Sr²⁺) | 13 |
| Fluoride (F⁻) | 1 |

Ions of Particular Concern

Of particular concern for use in common well treatment is the avoidance of water containing undesirably-high concentrations of inorganic ions having a valence state of two or more. As is well known in the oil and gas industry, such ions can interfere with the chemistry of forming or breaking certain types of viscous fluids that are commonly used in various well treatments.

Cations that are of common concern include dissolved alkaline earth metal ions, particularly calcium and magnesium ions, and may also include dissolved iron ions. An anion of common concern includes sulfate.

Regarding magnesium, the solubility of Mg(OH)₂ decreases with increasing pH, as shown in Table 6 showing the calculated solubility of Mg(OH)₂ with respect to pH, where Ksp=0.000165 moles/L.

TABLE 6

| pH | Ksp, moles/L |
|---|---|
| 7 | 1.8 |
| 8 | 0.18 |
| 9 | 0.018 |
| 10 | 0.0018 |
| 11 | 0.00018 |

Further, the solubility of Mg(OH)₂ decreases with increasing temperature. For example, the solubility decreases by an order of magnitude over a range of 0° C. (32° F.) to 60° C. (140° F.). John O'Connor, Tom O'Connor, Rick Twait, Water Treatment Plant Performance Evaluations and Operations, John Wiley & Sons, 2009, pp. 35-37. Extrapolating based on the reported change in Ksp with increasing temperature, the solubility of magnesium hydroxide would be expected to decrease another order of magnitude over a range of 60° C. (140 F) to 120 C (250 F).

Taking into account the effects of both higher pH and higher temperature, the solubility of Mg(OH)₂ decreases precipitously when both factors increase. This can cause a treatment fluid made with a water source having dissolved magnesium and then formed to have a high pH and used at a high temperature to be much more damaging to formation permeability.

### Desalination

Desalination or desalinization refers to any of several processes that remove some amount of salt (particularly NaCl) and other dissolved minerals from water having a high salt content.

Seawater or other water containing a high concentration of salt is desalinated to produce freshwater. Desalination requires large amounts of energy and specialized, expensive infrastructure, making it more expensive than freshwater from conventional sources, such as rivers or groundwater.

### Electrocoagulation

Electrocoagulation (“EC”) is also sometimes known as radio frequency diathermy or short wave electrolysis. EC is a technique used for wash water treatment. Electrocoagulation (“electro”, meaning to apply an electrical charge to water, and “coagulation”, meaning the process of changing the particle surface charge, allowing suspended matter to form an agglomeration) is an advanced and economical water treatment technology.

Coagulation is brought about primarily by the reduction of the net surface charge to a point where the colloidal particles, previously stabilized by electrostatic repulsion, can approach closely enough for van der Waals forces to hold them together and allow aggregation. The reduction of the surface charge is a consequence of the decrease of the repulsive potential of the electrical double layer by the presence of an electrolyte having opposite charge.

In the EC process, the coagulant is generated in situ by electrolytic oxidation of an appropriate anode material. In this process, charged ionic species—metals or otherwise—are removed from wastewater by allowing it to react with an ion having an opposite charge, or with floc of metallic hydroxides generated within the effluent.

In its simplest form, an electrocoagulation reactor is made up of an electrolytic cell with one anode and one cathode. When connected to an external power source, the anode material will electrochemically corrode due to oxidation, while the cathode will be subjected to passivation.

An EC system essentially consists of pairs of conductive metal plates in parallel, which act as mono-polar electrodes. It furthermore requires a direct current power source, a resistance box to regulate the current density and a multi-meter to read the current values. The conductive metal plates are commonly known as “sacrificial electrodes.” The sacrificial anode lowers the dissolution potential of the anode and minimizes the passivation of the cathode. The sacrificial anodes and cathodes can be of the same or of different materials.

Passing the water between a series of highly charged plates and adjusting the pH allows metallic ions (e.g., iron, magnesium, and barium) to precipitate out of solution and form small flocs, which can be more easily removed from the water with a combination of gravity settling or dissolved air floatation. Samples of the water are analyzed and the contaminants to be removed identified before the type of acid or base is determined After separation, the water is passed through a media filter to remove any lingering solids that did not get removed in the separation phase.

Preferably, the EC system uses the combination of a variable power supply, step-down transformer(s), and an AC to DC rectifier to produce the required treatment conditions (proper electric current level). The design reduces the overall power consumed by EC cells in order to achieve clarity in the treated water over a wide range of water conductivity.

The variable power supply outputs an alternating current (“AC”) typically in the range of 0 to 480 volts AC (“VAC”). The precise level is determined or controlled by a programmable logic controller (“PLC”) that sets the VAC output. The VAC output from the power supply is then delivered to the variable step-down transformer, which has a series of “taps” that further adjust the AC output prior to delivery to the rectifier. The taps are adjusted upwardly or downwardly depending on whether or not the desired operating current (or targeted current) is received by the EC cells within the system. The adjustment is made by monitoring the ratio of AC current to DC current.

Based on results to date, the methods and processes disclosed here will significantly reduce conventional transportation and disposal costs attributable to water hauling and treatment in hydraulic fracturing operations. EC treatment at the well site also helps to reduce the ability of the water to form scales and precipitants while reacting with formation and other metals and minerals in the fracturing water. Not only does it immediately enhance production but it also improves the production life of the well.

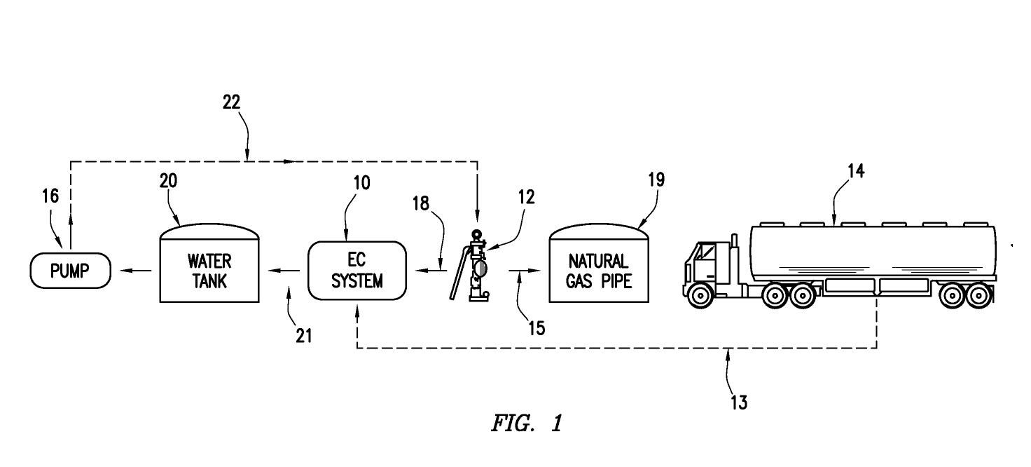

Referring to FIG. 1, as an example, seawater that is to be used in the hydraulic fracturing operation is delivered to the well site, as schematically indicated at 14 (by truck or other means). Newly delivered water (reference 13) is processed by the EC system 10 and then mixed with proppant particulates. It is then pumped (as illustrated at 16) down the bore at the well head location, thus introducing a hydraulic fracturing fluid into a subterranean formation (indicated at 17). This basic fracturing process is well-known in the gas industry, with the exception of using EC technology. Likewise, many different variations on the make-up and delivery of fracturing fluids and proppants have been used in the industry such as, for example, the materials described in U.S. Pat. No. 7,621,330 issued to Halliburton Energy Services, Inc. (“Halliburton”).

As a person familiar with hydraulic fracturing operations would know, when the fracturing process is deemed to be completed, pressure is released at the well head 12, thus resulting in flow back of the fracturing fluid back up through the well head 12. Natural gas or other produced well fluid is retrieved (indicated at 15) and piped to a storage facility (indicated at 19).

The EC system 10, which will be further described in greater detail below, uses an EC treatment process to separate the water from other components in the flow back. The EC-treated seawater is then held in a storage tank 20. Thereafter, it is mixed with to form a treatment fluid, such as a fracturing fluid.

For reasons described later, the EC system 10 will significantly reduce flow back parameters like turbidity and bacteria to very low levels. With the exception of sodium and chloride contaminants, other chemicals in the flow back are can be reduced via the EC treatment process.

Moreover, the EC-treated water by subsequent mixing with conventional proppant particulates is beneficial to the hydraulic fracturing process.

In addition to processing seawater, the EC system can be used for recycling of flow back water via the EC process 10 for use in subsequent treatment operations. The treatment of flow back water positively affects viscosity of the fracturing fluid (by reducing viscosity) and, consequently, affects the release of natural gas from the subterranean formation.

The EC process may reduce viscosity (μ) in Darcy's general equation:

$$Q = \frac{- κ A}{μ} \frac{( {P}_{b} - {P}_{a} )}{L}$$

The reduction in μ may be particularly acute with respect to diminishing imbibition in rocks less than 1 milliDarcy. By reducing μ and, consequently, imbibition, the fractured interface may be significantly less damaged, which benefits the recovery of the fracturing fluid (i.e., the flow back) and improves gas recovery from the well head.

The total discharge, Q (units of volume per time, e.g., m³/s) is equal to the product of the permeability (K units of area, e.g., m²) of the medium, the cross-sectional area (A) to flow, and the pressure drop (Pb—Pa), all divided by the dynamic viscosity μ (in SI units, e.g., kg/(m·s) or Pa·s), and the physical length L of the pressure drop.

The negative sign in Darcy's general equation is needed because fluids flow from high pressure to low pressure. If the change in pressure is negative (e.g., in the X-direction) then the flow will be positive (in the X-direction). Dividing both sides of the above equation by the area and using more general notation leads to:

$$q = \frac{- κ}{μ} ∇ P$$

where q is the filtration velocity or Darcy flux (discharge per unit area, with units of length per time, m/s) and gradient P is the pressure gradient vector. This value of the filtration velocity (Darcy flux) is not the velocity which the water traveling through the pores is experiencing.

The pore (interstitial) velocity (V) is related to the Darcy flux (q) by the porosity (φ). The flux is divided by porosity to account for the fact that only a fraction of the total formation volume is available for flow. The pore velocity would be the velocity a conservative tracer would experience if carried by the fluid through the formation.

Water treated by EC is likely to provide better flow rates underground in pressure-driven fracturing operations according to the following version of Darcy's law (relating to osmosis):

$$J = \frac{Δ P - Δ Π}{μ ( {R}_{f} + {R}_{m} )}$$

where:

J is the volumetric flux (m·s⁻¹),

ΔP is the hydraulic pressure difference between the feed and permeate sides of the membrane (Pa),

Δπ is the osmotic pressure difference between the feed and permeate sides of the membrane (Pa),

μ is the dynamic viscosity (Pas),

R_{f} is the fouling resistance (m⁻¹), and

Rₘ is the membrane resistance (m⁻¹).

In both the general and osmotic equations, increased discharge or volumetric flow is proportionate to decreased viscosity. Therefore, any treatment method that is likely to reduce viscosity in a fracturing fluid is also likely to improve the outcome of the fracturing process in terms of improvements to natural gas production.

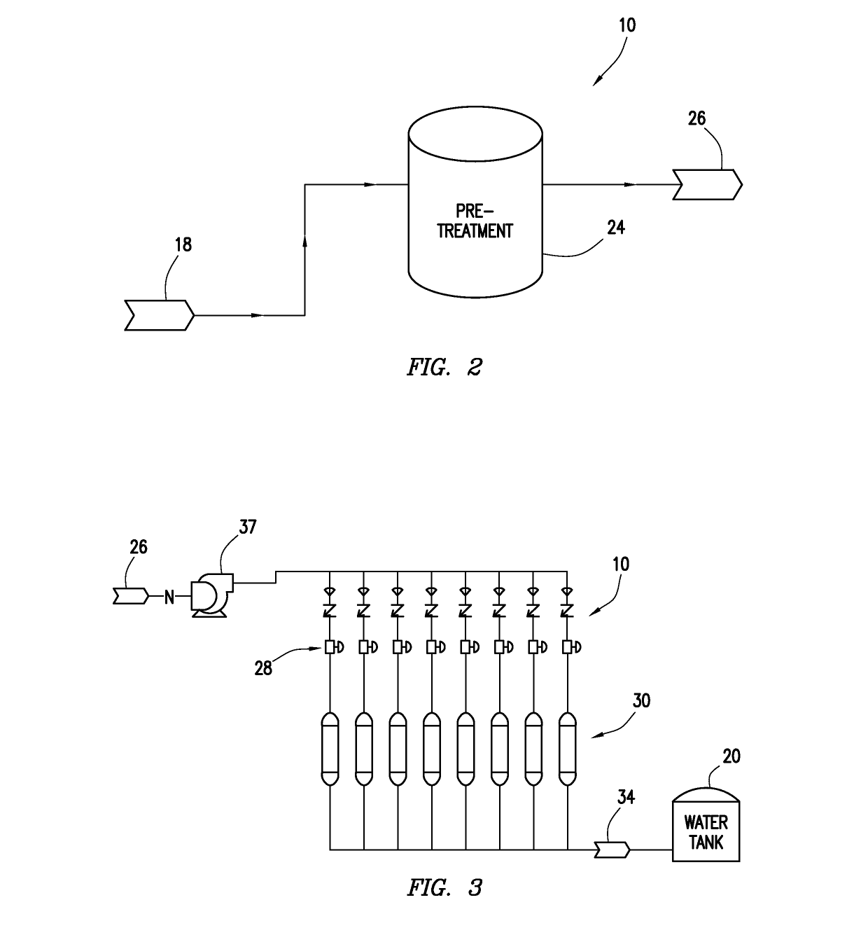

Once again, water that is delivered to the fracturing or well site may come from a variety of sources. Therefore, it may be desirable to use the EC system 10 for a threshold treatment of the water as it is delivered (thus reducing viscosity) and before mixing with sand or chemicals. As indicated above, the EC system 10 is otherwise self-contained so that it is easy to move to and from the well head 12. FIGS. 2 and 3 illustrate the basic operating parameters of the system 10.

In an embodiment including a scenario for recycling of flow back water, the flow back 18 is delivered to a pretreatment holding tank 24 (see FIG. 2). From there, the flow back is passed to a manifold feed system 28 (see FIG. 3) via line 26. The manifold system 28 distributes the flow back to a series of parallel EC treatment cells, indicated generally at 30. Each EC treatment cell has an internal configuration of charged plates that come into contact with the flow back.

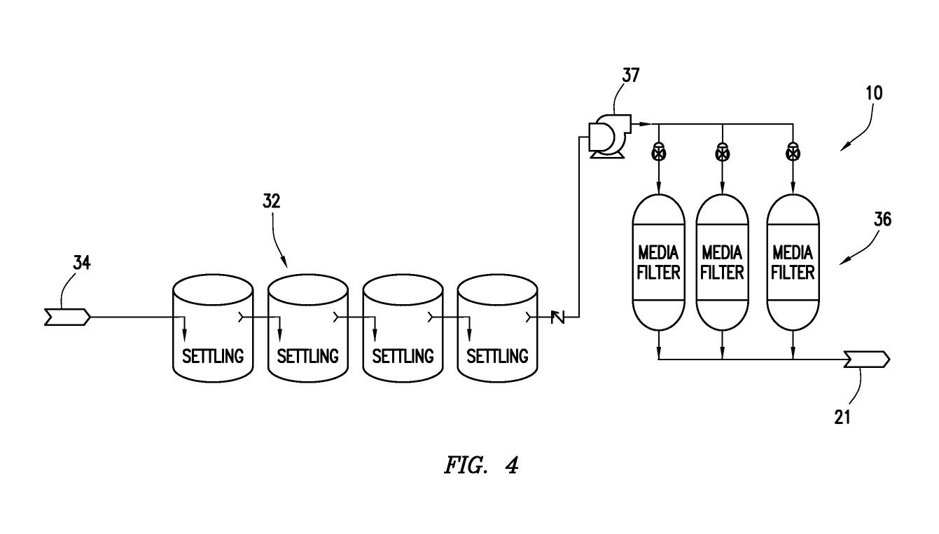

EC treatment cells with charged plate configurations have been in general use with EC systems for a long time. However, to the extent possible, it is desirable to select plate and flow-through configurations that create turbulent flow within each cell. It is undesirable to generate significant amounts of flocculation within the cells 30 themselves. After treatment by the cells 30, the flow back is returned to a series of settling tanks 32 (see FIG. 4) via line 34.

The EC treatment in the cells causes flocculent to be subsequently generated in the settling tanks 32. There, the contaminants are removed from the water via a settling out process. Solid materials are removed from the settling tanks 32 and trucked off-site for later disposal in a conventional manner The clarified water is then passed through sand media 36 (usually sand or crushed glass). Thereafter, the EC-treated water is passed onto the storage tank 20 (FIG. 1) for recycling in subsequent fracturing operations (see line 21 in FIGS. 1 and 4). Once again, the EC treatment positively improves the viscosity of the fluid (by reducing viscosity). Various pumps 37 are used at different points in the EC process to move the flow from one stage to the next.

There will be some variables in the overall EC treatment process from one site to the next because of chemical and similar differences in the fracturing fluid or flow back. Similarly, there may be variations that are dependent on the content of delivered water in those situations where the EC treatment process is used initially to treat incoming water before it is used in a fracturing operation.

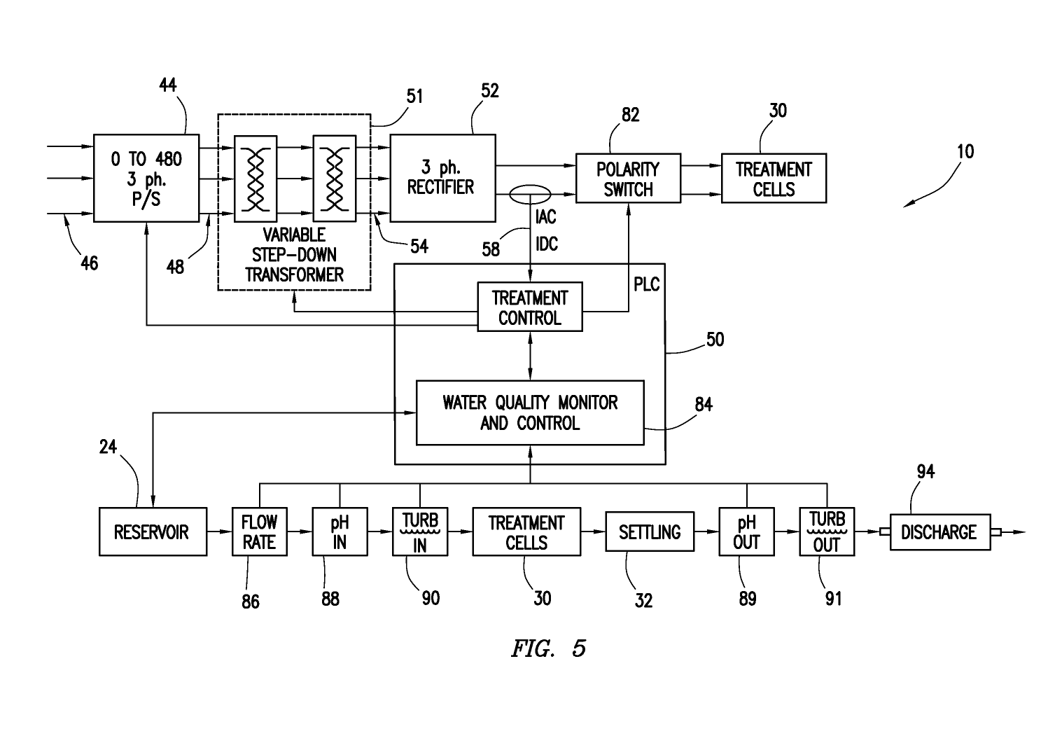

FIG. 5 is a schematic that illustrates the control logic for the EC system 10 illustrated in FIGS. 1-3. The EC system 10 utilizes an adjustable power supply 44. Three-phase power is delivered to the power supply 44 at 480 volts AC (“VAC”) (schematically indicated at 46 in FIG. 4). The output of the power supply 44 (indicated generally at 48) is a variable that is adjusted from 0 to 480 VAC by a controller 50. The power supply output 48 is delivered to a variable step transformer 51 that further step down the AC voltage from the power supply 40 before delivering it to a three-phase rectifier 52.

Both the power supply 44 and transformer 51 are conventional power system components when standing alone. The transformer 51 includes a series of “taps,” which would be familiar to a person having knowledge of transformer systems. The “taps” provide different set points for stepping down the voltage across the transformer according to the power current level needed by the EC system 10.

The three-phase rectifier 52 converts the output (see 54) from the transformer 51 to direct current (“DC”). The three-phase rectifier 52 is also a conventional component, standing alone.

The transformer 51 evens out or prevents current “spikes” that are typical to the way adjustable power supplies work. The EC system 10 is adjusted to operate at a target current that maximizes EC cell operation. Part of this process involves imparting a charge to the fluid being treated without instigating significant amounts of flocculation in individual cells.

That is, the target current is conducted through the flow back (or other fluid under treatment) in the EC treatment cells 30 via the charged plates within the cells. The target current may be set manually by the EC system operator, depending on the water quality of the flow back after EC treatment. Alternatively, it may be set automatically via an algorithm described below:

I_{target}=Iᵤₛₑᵣ−((Turbₒᵤₜ−Turb_{goal})+(Turbᵢₙ−Turb_{cal}))×(1/Flow)

### Where:

I_{target}=Current system will maintain and hold to provide treatment;
Iᵤₛₑᵣ=Current set point user has specified to provide the gross level of treatment;
Turbₒᵤₜ=Turbidity out of treatment train;
Turb_{goal}=Desired turbidity out of the system;
Turbᵢₙ=Turbidity of the water to be treated;
Turbₒᵤₜ=Turbidity value to which the system is baseline; and
Flow=Flow rate through the treatment cells.

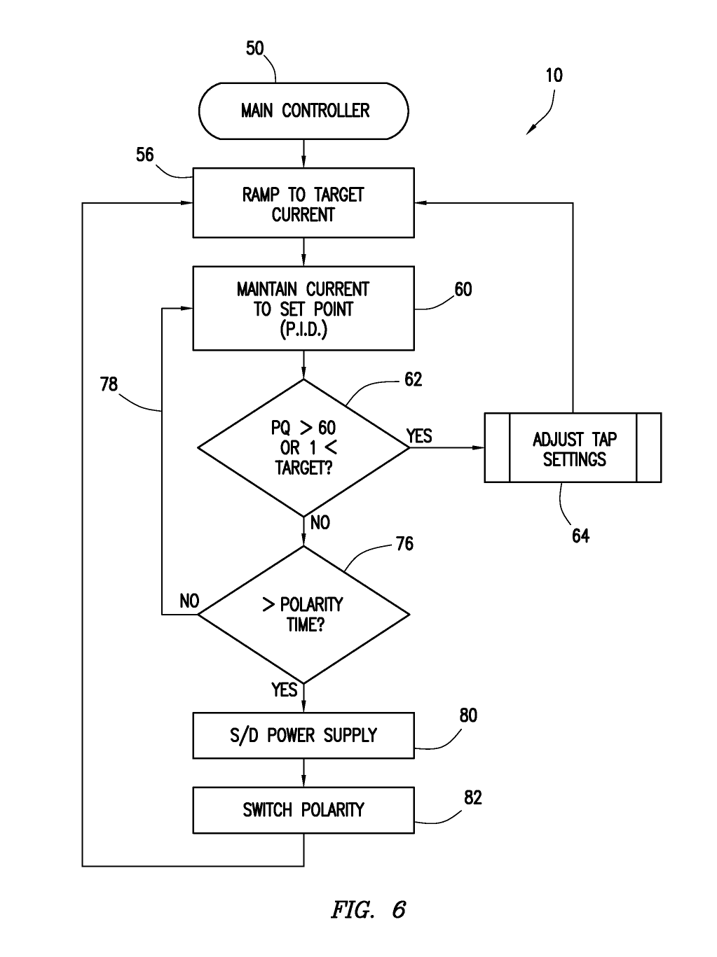

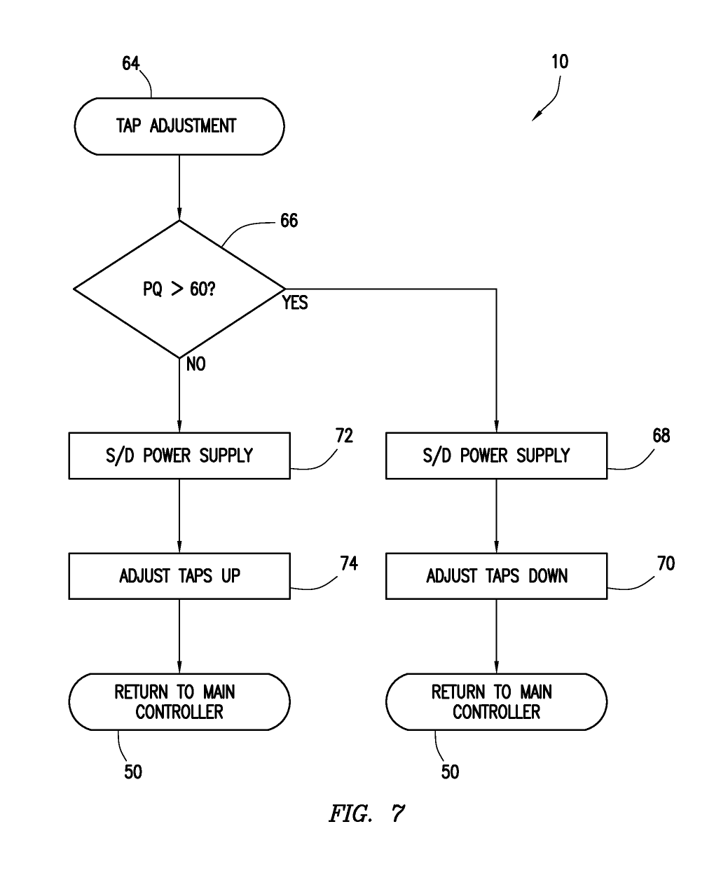

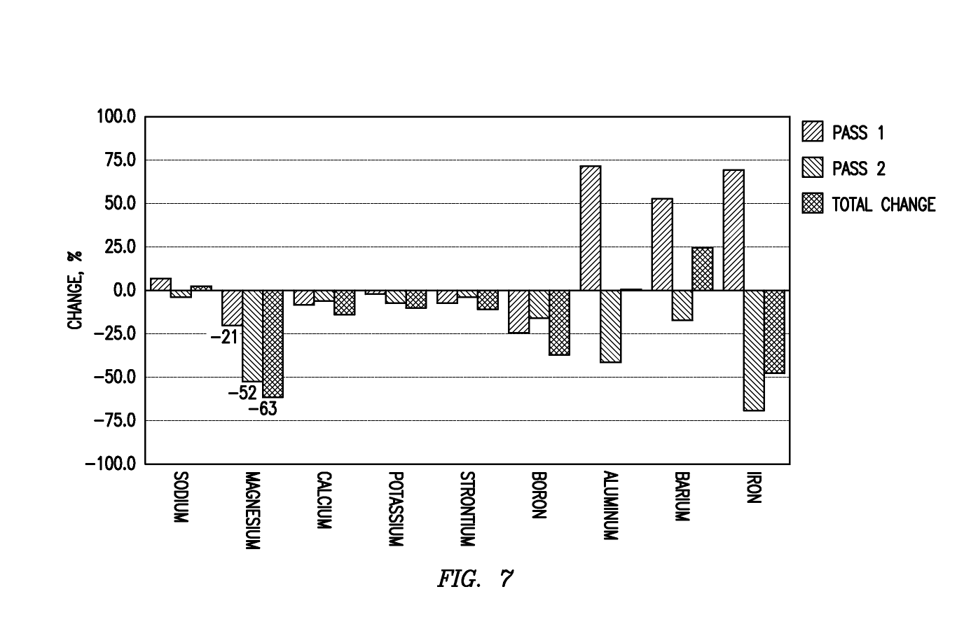

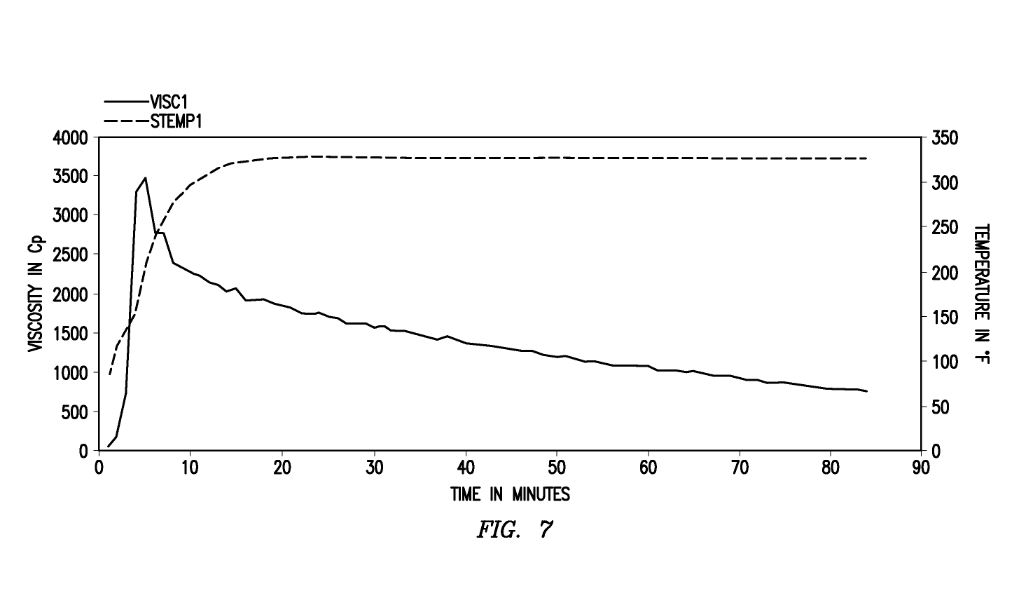

The controller 50 is a conventional programmable logic controller. The basic control of current to the treatment cells 30 will now be described by referring to FIG. 6.

The controller 50 ramps up to the target current 56 as follows. Reference numeral 58 (in FIG. 5) reflects the controller's constant monitoring of DC current (I_{DC}) and AC current (I_{AC}) output from the transformer 51 and three-phase rectifier 52. The EC system 10 uses a proportional integral derivative algorithm (PID) to maintain cell current to a set point defined by the user, as shown at 60. PIDs are generic algorithms that are well-known.

Unique to the present invention, the control logic includes a “power quality” (“PQ”) calculation that is based on the following equation:

$$PQ = \frac{{I}_{AC}}{{I}_{DC}} \times 100$$

Both the AC (I_{AC}) and DC (I_{DC}) current values are sensed following rectification. The DC current (I_{DC}) is the averaged direct output from the rectifier 52. The AC current (I_{AC}) is the residual alternating current from the rectifier 52. The DC and AC values reflect different characteristics from the same wave form output by the rectifier 52.

The tap settings in the transformer 51 are adjusted, as shown at 62, depending on the power quality (“PQ”) value. If the PQ is equal to or greater than 60 (as an example), or alternatively, if the sensed current is less than the target current, then the controller 50 adjusts the transformer tap settings (reference 64).

The control logic for the tap adjustment 64 is further illustrated in FIG. 6. Transformer taps are adjusted either upwardly or downwardly depending on the PQ calculation (referenced at 66). If PQ is equal to or greater than 60, for example, then the controller shuts down the power supply 68 (see, also, reference 44 in FIG. 4) for a brief period. At that point in time, the transformer taps are adjusted downwardly (item 70). As a skilled person would know, if the transformers have a set of five taps, then they are selected one at a time in the direction that steps voltage down another step (with the process repeated iteratively until the desired result is achieved. If PQ is not equal to or greater than 60, then the power supply is similarly shut down (see item 72), but the transformer taps are instead adjusted upwardly (reference 74).

Returning to FIG. 6, if the current set point is not outside the range specified in control logic block 62 (that is, the current setting is acceptable), then the controller 50 checks the polarity timing function 76. In preferred form, the EC system 10 is set to maintain polarity across a set of plates inside the EC treatment cells 30 for a specified period of time. The control logic will loop through the sequence just described (item 78) until the next polarity time-out is reached. At that point in time, the controller 50 once again shuts down the power supply (see item 80) and switches the polarity 82 of the plates inside the treatment cells to run until the next time-out period.

Referring again to FIG. 5, the controller 50 may also monitor incoming and outgoing flow rate (86) pH (88, 89), turbidity (90, 91), and other factors relating to the flow back via conventional sensor control logic 84. The pH of the flow back may need to be adjusted upstream of the EC cells so that no flocculation occurs in the flow back before it reaches and passes through the treatment cells 30. Flow rates and pH and turbidity factors 86, 88, 89, 90, 91 may be continually and automatically monitored by the controller 50. Depending on the quality of the output from the settling tanks 32, and after filtering (see 36, FIG. 4), the treated flow back could be recirculated through the system (not shown) until the EC system's operation is stabilized. Otherwise, the treatment water is discharged (reference 94) to the water tank 20 for recycling in the next hydraulic fracturing operation. Once again, the same basic treatment process is used if delivered water is treated prior to any use as a fracturing fluid.

The use of EC technology to enhance hydraulic fracturing in natural gas applications offers many advantages. The benefits of reduced viscosity were previously described. In addition, EC creates significant bacterial kill in the treated water—whereas bacteria in fracturing fluid is otherwise known to be undesirable. The direct field current generated in the EC cells 30 serves to kill bacteria. If aluminum plates are used in the cells 30, they will also generate aluminum hydrate which also affects certain bacterial types.

In preferred form, stable operation of the EC system 10 involves no or minimum chemical adjustment to the flow, with the treatment relying on the cell plate charge delivered by current control. It is preferred to deliver target currents in the range of 100 to 140 amps DC. These high currents can be achieved because of proper impedance matching provided by the variable step-down transformer 51 described above. It is also more power efficient to use a 3-phase rectifier (reference 52) in lieu of single-phase rectification. Different EC cell designs are possible. However, it is desirable to use cell designs that are capable of dissipating the heat potentially generated by putting high current loads on the plates.

### Other Treatment Fluid Additives

In certain embodiments, the treatment fluids also can optionally comprise other commonly used fluid additives, such as those selected from the group consisting of surfactants, bactericides, fluid-loss control additives, stabilizers, chelants, scale inhibitors, corrosion inhibitors, hydrate inhibitors, clay stabilizers, relative permeability modifiers (such as HPT-1™ commercially available from Halliburton Energy Services, Duncan, Okla.), sulfide scavengers, degradable particulates (such as poly(glycolic acid) (“PGA”), poly(lactic acid) (“PLA”), and their copolymers), fibers, nanoparticles, and any combinations thereof.

In addition, it is contemplated that the treatment fluid can be foamed with a gas such as nitrogen using an appropriate foaming surfactant.

Method of Treating a Well with the Treatment Fluid

A method of treating a well is provided including the steps of: forming a treatment fluid according to the invention; and introducing the treatment fluid into the well.

A treatment fluid can be prepared at the job site, prepared at a plant or facility prior to use, or certain components of the treatment fluid can be pre-mixed prior to use and then transported to the job site. Certain components of the fluid may be provided as a “dry mix” to be combined with fluid or other components prior to or during introducing the fluid into the well.

In certain embodiments, the preparation of a fluid can be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

Often the step of delivering a fluid into a well is within a relatively short period after forming the fluid, e.g., less within 30 minutes to one hour. More preferably, the step of delivering the fluid is immediately after the step of forming the fluid, which is “on the fly.”

It should be understood that the step of delivering a fluid into a well can advantageously include the use of one or more fluid pumps.

In an embodiment, the step of introducing is at a rate and pressure below the fracture pressure of the treatment zone. For example, in an embodiment, the step of introducing comprises introducing under conditions for gravel packing the treatment zone.

In a preferred embodiment, the step of introducing comprises introducing under conditions for fracturing a treatment zone. The fluid is introduced into the treatment zone at a rate and pressure that are at least sufficient to fracture the zone.

In some embodiments, the treatment fluids may be placed in a subterranean formation utilizing a hydrajet tool. The hydrajet tool may be capable of increasing or modifying the velocity or direction of the flow of a fluid into a subterranean formation from the velocity or direction of the flow of that fluid down a well bore. One of the potential advantages of using a hydrajet tool is that a fluid may be introduced adjacent to and localized to specific areas of interest along the well bore without the use of mechanical or chemical barriers. Some examples of suitable hydrajet tools are described in U.S. Pat. Nos. 5,765,642, 5,494,103, and 5,361,856, which are hereby incorporated by reference.

Designing a fracturing treatment usually includes determining a designed total pumping time for the treatment of the treatment zone or determining a designed total pumping volume of fracturing fluid for the treatment zone. The tail end of a fracturing treatment is the last portion of pumping time into the zone or the last portion of the volume of fracturing fluid pumped into the zone. This is usually about the last minute of total pumping time or about the last wellbore volume of a fracturing fluid to be pumped into the zone. The portion of pumping time or fracturing fluid volume that is pumped before the tail end of a fracturing stage reaches into a far-field region of the zone.

A person of skill in the art is able to plan each fracturing treatment in detail, subject to unexpected or undesired early screenout or other problems that might be encountered in fracturing a well. A person of skill in the art is able to determine the wellbore volume between the wellhead and the zone. In addition, a person of skill in the art is able to determine the time within a few seconds in which a fluid pumped into a well should take to reach a zone.

In addition to being designed in advance, the actual point at which a fracturing fluid is diverted from a zone can be determined by a person of skill in the art, including based on observed changes in well pressures or flow rates.

Fracturing methods can include a step of designing or determining a fracturing treatment for a treatment zone of the subterranean formation prior to performing the fracturing stage. For example, a step of designing can include: (a) determining the design temperature and design pressure; (b) determining the total designed pumping volume of the one or more fracturing fluids to be pumped into the treatment zone at a rate and pressure above the fracture pressure of the treatment zone; (c) designing a fracturing fluid, including its composition and rheological characteristics; (d) designing the pH of the continuous phase of the fracturing fluid, if water-based; (e) determining the size of a proppant of a proppant pack previously formed or to be formed in fractures in the treatment zone; and (f) designing the loading of any proppant in the fracturing fluid.

Any of the fracturing methods can include a step of monitoring to help determine the end of a fracturing stage. The end of a fracturing stage is the end of pumping into a treatment zone, which can be due to screenout at or near the wellbore or other mechanical or chemical diversion of fluid to a different treatment zone.

One technique for monitoring is measuring the pressure in the wellbore along the treatment zone. Another technique includes a step of determining microseismic activity near the zone to confirm an increase in fracture complexity in the treatment zone.

It is common us use multi-stage fracturing of a subterranean formation having ultra-low permeability. A fracturing method can further include repeating the steps of one fracturing stage for another treatment zone.

After the step of introducing a treatment fluid, wherein the treatment comprising a breaker, method includes allowing time for breaking the viscosity in the well. This preferably occurs with time under the conditions in the zone of the subterranean fluid.

In an embodiment, the step of flowing back is within 72 hours of the step of introducing. In another embodiment, the step of flowing back is within 24 hours of the step of introducing.

Preferably, after any such well treatment, a step of producing hydrocarbon from the subterranean formation is the desirable objective.

### Example

To facilitate a better understanding of the present invention, the following examples of certain aspects of some embodiments are given. In no way should the following examples be read to limit, or define, the entire scope of the invention.

Table 7 shows the raw data acquired from an EC flow test where an influent fluid of seawater was passed through Halliburton's CEANWAVE™ EC system twice with compositional analyses being performed before and after each pass through the system.

TABLE 7

| Source | Influent | EC Pass 1 | EC Pass 2 |
|---|---|---|---|
| Specific Gravity | 1.024 | 1.024 | 1.021 |
| pH | 7.86 | 9.44 | 9.53 |
| Bicarbonate | 158.8 | 5.88 | 0 |
| Carbonate | 0 | 57.85 | 37.6 |
| Chloride | 18,211 | 17,960 | 16,703 |
| Sulfate | 2,700 | 2,400 | 2,200 |
| Aluminum | 0.274 | 0.47 | 0.272 |
| Boron | 5.59 | 4.18 | 3.5 |
| Barium | 0.11 | 0.169 | 0.138 |
| Calcium | 444 | 408 | 380 |
| Iron | 0.107 | 0.181 | 0.055 |
| Potassium | 432 | 421 | 388 |
| Magnesium | 1,259 | 989 | 471 |
| Sodium | 10,869 | 11,587 | 11,120 |
| Strontium | 8.45 | 7.9 | 7.5 |
| TDS | 33,642 | 33,408 | 30,916 |
| TSS | 8.03 | 2.02 | 15.3 |

FIG. 8 is a graph demonstrating that the concentration of magnesium in seawater can be reduced by passing through an electrocoagulation unit (e.g., Halliburton's CLEANWAVE™ EC treatment). The columns represent the change in various cation ion concentrations from the initial concentrations after two passes through the EC unit.

As can be seen in FIG. 8, the magnesium ion concentration is reduced by 62% after passing through the EC unit twice. Except for sodium and potassium cations, some other cations are also reduced, some by larger percentages, but since these other cations are present in the starting fluid at very low concentrations, the change has little effect on the total fluid composition. Magnesium, however, is present at high a concentration (greater than 1,000 mg/l) in the initial fluid and this reduction in concentration provides a major improvement on pH behavior of the treatment fluid and on the resulting fluid turbidity.

FIG. 9 is a graph of the FANN™ Model 50 rheology results using a 4.2 kg/m³ (35 lb/Mgal) zirconium-based crosslink fluid at 163° C. (325° F.) with EC treated seawater that was passed through the system once, where the crosslink pH was 10.3.

### CONCLUSION

Therefore, the present invention is well adapted to attain the ends and advantages mentioned as well as those that are inherent therein.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

The various elements or steps according to the disclosed elements or steps can be combined advantageously or practiced together in various combinations or sub-combinations of elements or sequences of steps to increase the efficiency and benefits that can be obtained from the invention.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

1. A method of treating a well, the method comprising steps of:
(A) treating a first aqueous fluid comprising seawater with electrocoagulation to obtain a second aqueous fluid, wherein the second aqueous fluid has a reduced concentration of magnesium ions relative to an original concentration of magnesium ions in the first aqueous fluid;
(B) forming a treatment fluid comprising: (1) an aqueous phase, wherein the aqueous phase comprises the second aqueous fluid and wherein the aqueous phase has a pH at least about 9, and (ii) a polymeric viscosity-increasing agent in the aqueous phase; and
(C) introducing the treatment fluid into a well.

2. The method according to claim 1, wherein a bottom hole circulation temperature is at least about 93° C. (200° F.).

3. The method according to claim 1, wherein the step of treating the first fluid with electrocoagulation further comprises steps of:
(A) adding caustic to the first aqueous fluid to increase the pH to at least about 9;
(B) passing the first aqueous fluid through an electrocoagulation cell; and
(C) separating at least some of the magnesium ions from the first aqueous fluid to obtain the second aqueous fluid.

4. The method according to claim 1, wherein the original concentration of magnesium ions in the first aqueous fluid is greater than 1,000 mg/kg (ppm).

5. The method according to claim 4, wherein the reduced concentration of magnesium ions in the second aqueous fluid is less than 500 mg/kg (ppm).

6. The method according to claim 1, wherein the reduced concentration of magnesium ions is less than 50% of the original concentration of magnesium ions in the first aqueous fluid.

7. The method according to claim 1, wherein the first aqueous fluid comprises at least 5,000 mg/l of sodium ions.

8. The method according to claim 1, wherein the first aqueous fluid comprises at least 80% by weight seawater.

9. The method according to claim 1, wherein the aqueous phase of the treatment fluid comprises at least 80% by weight of the second aqueous fluid.

10. The method according to claim 1, wherein the aqueous phase of the treatment fluid comprises at least 5,000 mg/l of sodium ions.

11. The method according to claim 1, wherein the aqueous phase of the treatment fluid has a pH of at least 10.

12. The method according to claim 1, wherein the viscosity increasing agent is selected from the group consisting of guar, guar derivatives, cellulose derivatives, and any combination thereof.

13. The method according to claim 1, wherein the treatment fluid further comprises a crosslinking agent for the viscosity-increasing agent.

14. The method according to claim 13, wherein the crosslinking agent comprises a borate.

15. The method according to claim 1, wherein the treatment fluid additionally comprises a dispersed solid particulate.

16. The method according to claim 15, wherein the solid particulate is a proppant.

17. The method according to claim 1, wherein the step of introducing farther comprises; directing the treatment fluid into a zone of a subterranean formation penetrated by a wellbore of the well.

18. The method according to claim 17, wherein the step of introducing further comprises: introducing the treatment fluid into the zone at a pressure above the fracture pressure for the zone.

19. The method according to claim 1, additionally comprising steps of:
(D) breaking a viscosity of the treatment fluid in the well; and
(E) flowing back fluid from the well.

20. The method according to claim 19, wherein the step of breaking comprises: lowering the pH of the treatment fluid to less than about 8.

21. A method of fracturing a zone of a subterranean formation penetrated by a wellbore of a well, the method comprising steps of:
(A) treating a first aqueous fluid comprising seawater with electrocoagulation to obtain a second aqueous fluid, wherein the second aqueous fluid has a reduced concentration of magnesium ions relative to an original concentration of magnesium ions in the first aqueous fluid;
(B) forming a treatment fluid comprising: (i) an aqueous phase; wherein the aqueous phase comprises the second aqueous fluid and wherein the aqueous phase has a pH at least about 9, (ii) a polymeric viscosity-increasing agent in the aqueous phase; and (iv) a borate crosslinker;
(C) introducing the treatment fluid into the zone at a rate and pressure sufficient to create or enhance a fracture in the subterranean formation;
(D) breaking the viscosity of the treatment fluid in the zone by reducing the pH of the fluid to less than about 8; and
(E) flowing back fluid from the zone.

22. A method of treating a well, the method comprising steps of:
(A) treating a First aqueous fluid comprising seawater with electrocoagulation to obtain a second aqueous fluid, wherein the second aqueous fluid has a reduced concentration of magnesium ions relative to an original concentration of magnesium ions in the first aqueous fluid;
(B) forming a treatment fluid comprising: (i) an aqueous phase, wherein the aqueous phase comprises the second aqueous fluid, and (ii) a polymeric viscosity-increasing agent in the aqueous phase; and
(C) introducing the treatment fluid into a well, wherein a bottom hole circulation temperature is at least about 93° C. (200° F.).

23. The method according to claim 22, wherein the step of treating the first fluid with electrocoagulation further comprises the steps of:
(A) adding caustic to the first aqueous fluid to increase the pH to at least about 9;
(B) passing the first aqueous fluid through an electrocoagulation cell; and
(C) separating at least some of the magnesium ions from the first aqueous fluid to obtain the second aqueous fluid.

24. The method of claim 6, wherein the reduced concentration of magnesium ions reduces the precipitation of Mg(OH)₂ solids that occurs with the aqueous phase having a pH at least about 9.
